(19) United States
(12) Patent Application Publication
(10) Pub. No.: US 2009/0034752 A1
(43) Pub. Date: Feb. 5, 2009

(54) CONSTRAINTED SWITCHED ADAPTIVE BEAMFORMING

(75) Inventors: Xianxian Zhang, San Diego, CA (US); Vishu Viswanathan, Plano, TX (US); Jacek Stachurski, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/180,107

(22) Filed: Jul. 25, 2008

Related U.S. Application Data
(60) Provisional application No. 60/952,722, filed on Jul. 30, 2007.

(51) Int. Cl. H04R 3/00

(52) U.S. Cl. 381/92

(57) ABSTRACT

An audio device, comprising a microphone array, a constrained switched adaptive beamformer with input coupled to said microphone array, said beamformer including (i) a first stage speech adaptive beamformer with first adaptive filters having a first adaptive step size, and (ii) a second stage noise adaptive beamformer with second adaptive filters having a second adaptive step size, and a single channel speech enhancer with input coupled to an output of said constrained switched adaptive beamformer.

### CROSS-REFERENCE TO RELATED APPLICATIONS

This application claims priority from provisional patent application No. 60/652,722, filed Jul. 30, 2007. The following co-assigned, co-pending patent applications disclose related subject matter: application Ser. No. 11/165,902, filed Jun. 24, 2005 [TI-35386] and 60/948,237, filed Jul. 6, 2007 [TI-64450]. All of which are herein incorporated by reference.

### BACKGROUND OF THE INVENTION

The present invention relates to digital signal processing, and more particularly to methods and devices for speech enhancement.

The use of cell phones in cars demands reliable hands-free, in-car voice capture within a noisy environment. However, the distance between a hands-free car microphone and the speaker will cause severe loss in speech quality due to noisy acoustic environments. Therefore, much research is directed to obtain clean and distortion-free speech under distant talker conditions in noisy car environments.

Microphone array processing and beamforming is one approach which can yield effective performance enhancement. Zhang et al. CSA-BF: A Constrained Switched Adaptive Beamformer for Speech Enhancement and Recognition in Real Car Environments, 11 IEEE Tran. Speech Audio Proc. 433 (November 2003), and U.S. Pat. No. 6,937,980 provide examples of multi-microphone arrays mounted within a car (e.g., on the upper windshield in front of the driver) which connect to a cellphone for hands-free operation. However, these system microphone array systems need improvement in both quality and portability.

### SUMMARY OF THE INVENTION

The present invention provides constrained switched adaptive beamformers with adaptive step sizes and post processing which can be used for a microphone array on a cellphone.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D illustrate preferred embodiment system with constraint switched adaptive beamformer plus post processing and cellphone microphone array for input.

FIGS. 2A-2D illustrate a constrained switched adaptive beamformer and energy estimator response.

FIGS. 3A-3B show a processor and network communication.

### DESCRIPTION OF THE PREFERRED EMBODIMENTS

### 1. Overview

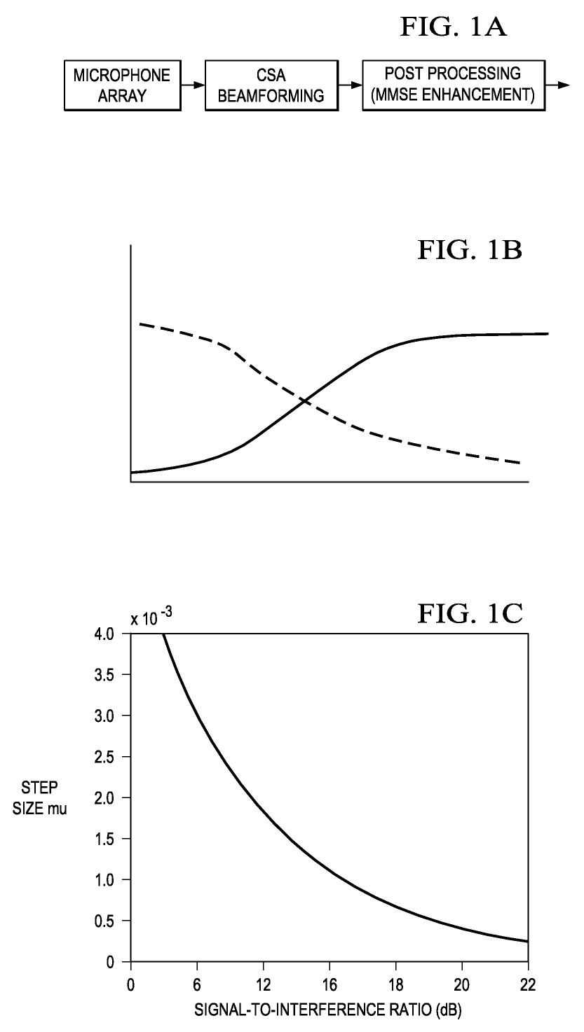

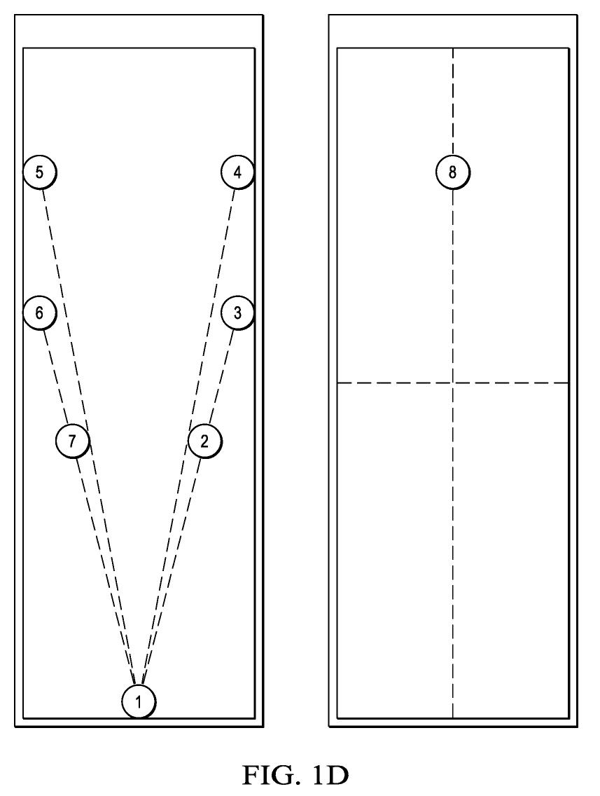

Preferred embodiment methods include constrained switched adaptive beamforming (CSA-BF) with separate step size adaptations for the speech adaptive beamformer stage and the noise adaptive beamformer stage together with speech-enhancement post processing; see FIG. 1A. The speech adaptive step size depends upon a filter coefficient measurement and also error size (i.e., FIG. 1B); whereas, the noise adaptive step size depends upon signal to interference ratio (i.e., FIG. 1C). A frontside (front panel) seven-microphone array (or sub-array) on a cellphone (i.e., FIG. 1D) can provide the input for the CSA-BF.

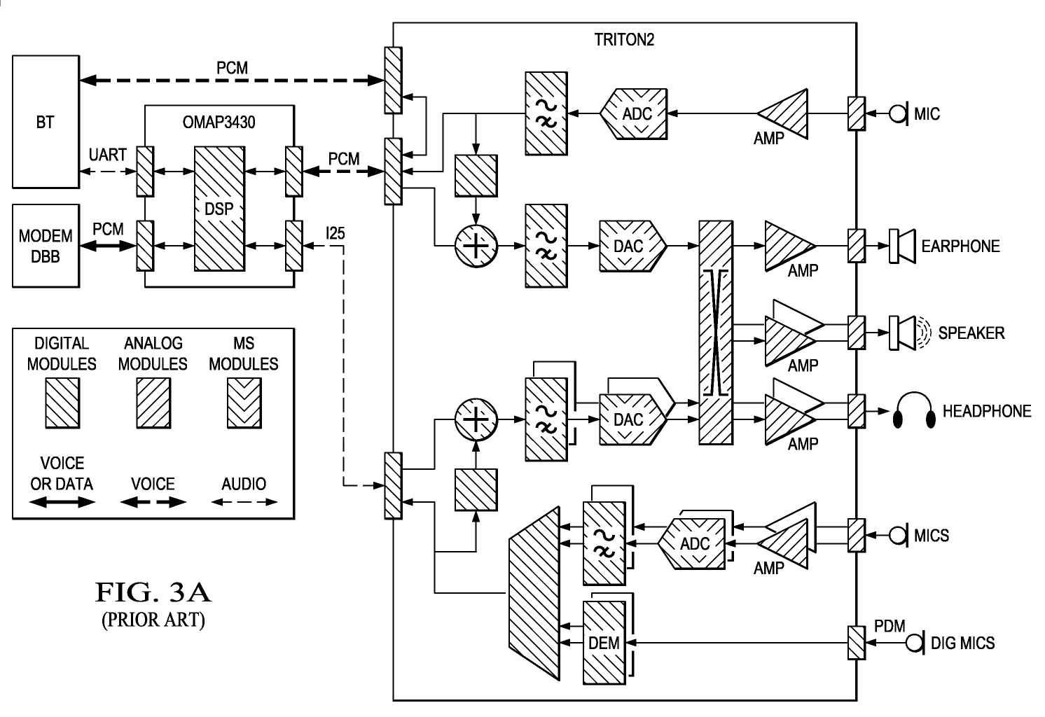

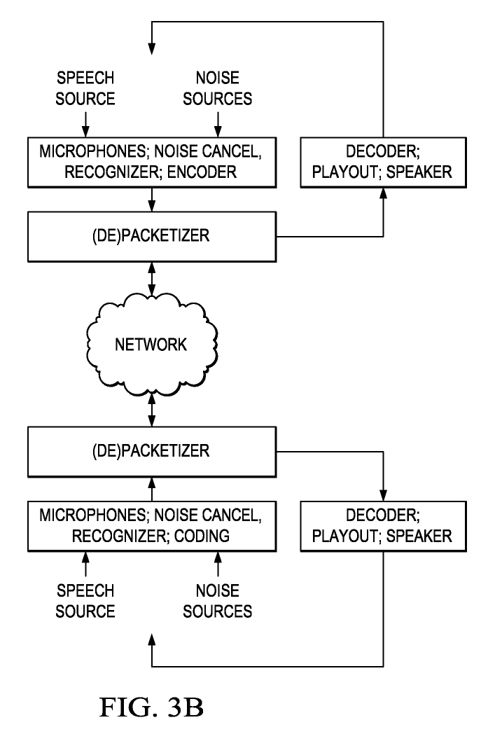

Preferred embodiment systems, such as cell phones or other mobile audio devices which can operate hands-free in noisy environments, perform preferred embodiment methods with digital signal processors (DSPs) or general purpose programmable processors or application specific circuitry or systems on a chip (SoC) such as both a DSP and RISC processor on the same chip; FIG. 3A shows functional blocks of a processor which includes video capabilities as in a camera cellphone. A program stored in an onboard ROM or external flash EEPROM for a DSP or programmable processor could perform the signal processing. Analog-to-digital converters and digital-to-analog converters provide coupling to the real world, and modulators and demodulators (plus antennas for air interfaces) provide coupling for transmission waveforms. The noise-cancelled speech can also be encoded, packetized, and transmitted over networks such as the Internet; see FIG. 3B.

### 2. Constrained Switched Adaptive Beamformer

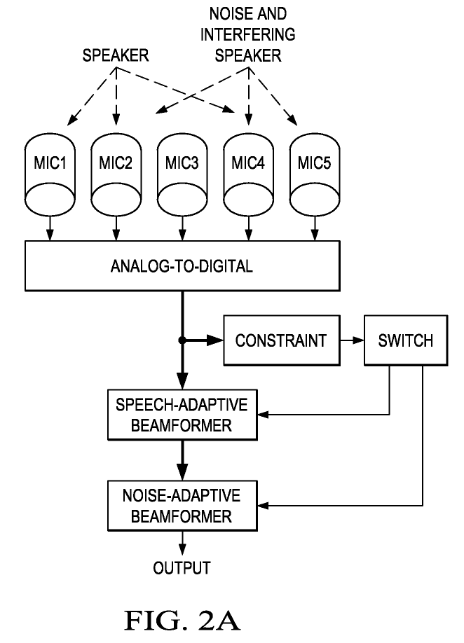

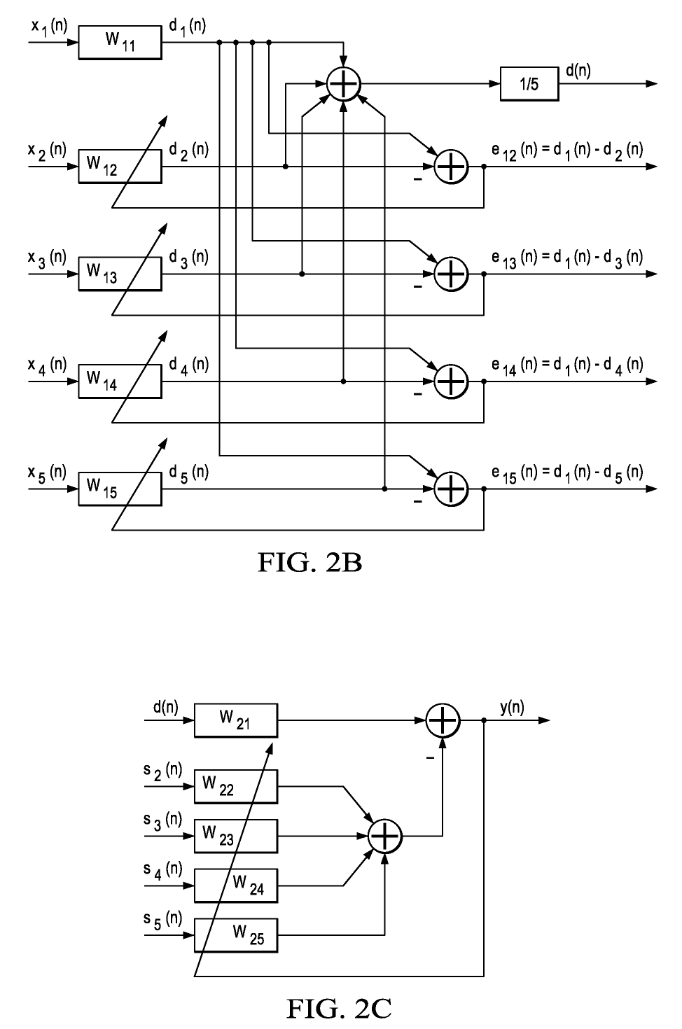

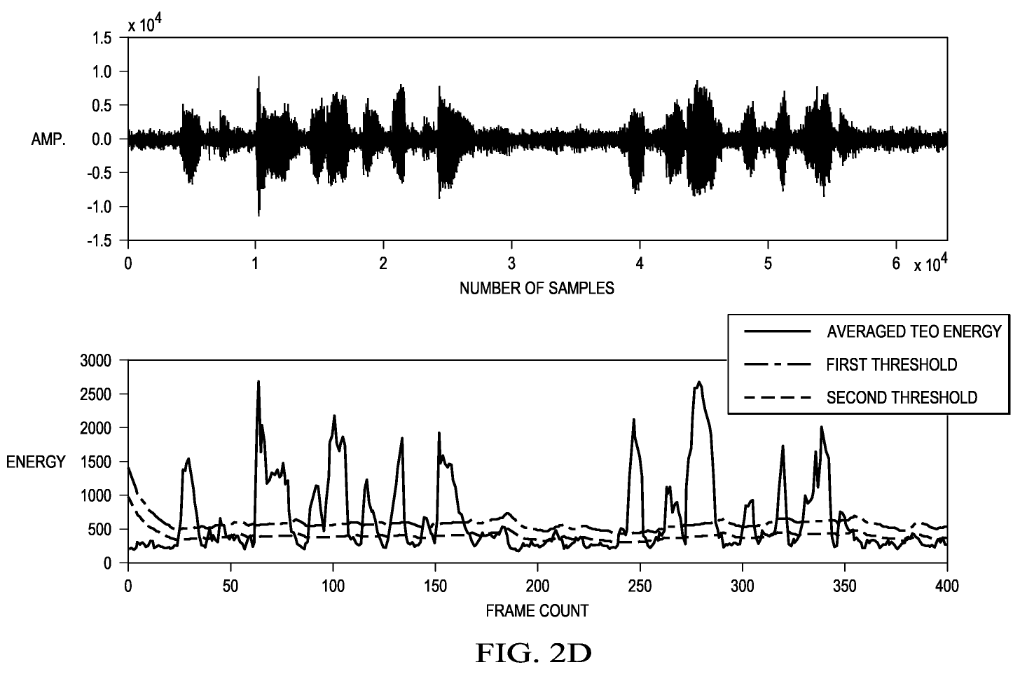

Preliminarily, consider a generic constrained switched adaptive beamformer (CSA-BF) as illustrated in block diagrams FIGS. 2A-2C. As shown in FIG. 2A, the CSA-BF includes a constraint section (CS), a switch, a speech adaptive beamformer (SA-BF), and a noise adaptive beamformer (NA-BF). Generally, the CS detects desired speech and noise (including interfering speech) segments within the input from a microphone array: if a speech source is detected, the switch will activate the SA-BF (shown in FIG. 2B) to adjust (steer) the beam to enhance the desired speech. When the SA-BF is active, the NA-BF is disabled to avoid speech leakage. If, however, the CS detects a noise source, the switch will activate the NA-BF (shown in FIG. 2C) to adjust (steer) the beam to the noise source and switch off the SA-BF to avoid the beam pattern for the desired speech from being corrupted by the noise. The combination of both SA-BF and NA-BF processing achieves noise cancellation for interference in both time and spatial orientation. The following subsections provide more detail of the CS, SA-BF, and NA-BF operation when in a car with the driver as the source of the desired speech.

### A. Constraint Section

The input signal from a microphone can be one or any combination of the desired speech signal (i.e., the driver's voice in a car), unwanted speech signal (i.e., speech from another person in the car), and various environmental car noise sources (vibration noise, turn signal noise, noise of a car passing, wind noise from open windows, etc). In order to enhance the desired speech and suppress noise (including undesired speech), we must first identify and separate speech and noise occurrences. Therefore, the main function of the constraint section (CS) is to identify the primary speech and interference sources, and this may be based on the following three criteria. (1) Maximum averaged energy; (2) LMS adaptive filter; and (3) Bump noise detector. Consider these criteria (1)-(3) in more detail.

(1) When a microphone array is used in the car, it is always positioned on the windshield near the sun visor in front of the driver who is assumed to be the speaker of interest. Therefore, the driver to microphone array distance will be smaller than the distance to other passengers in the vehicle, and so speech from the driver's direction will have on the average the highest intensity of all sources present. Thus, the first criterion is based on frame energy averages as follows:
(a) if the current signal energy is greater than a speech threshold, then the current signal will be a speech candidate;
(b) if the current signal energy is less than a noise threshold, then the current signal will be a noise candidate.

To measure the current signal energy, the preferred embodiments employ the nonlinear energy operator developed by Teager, as follows:

ψ[x(n)]=x(n)²−x(n+1)x(n−1)

Here, ψ is referred to as the TEO, and x(n) is the sampled current signal. In order to overcome instances of impulsive high energy interference such as road noise, preferred embodiment implementations use an analysis window consisting of 256 samples instead of the three sample window needed to compute the average Teager energy. Assume the analysis window size is N, then the average Teager signal energy of this window is given as:

Ē_{signal}=(1/N)Σ_{0≦n≦N-1} {x(n)²−x(n+1)x(n−1)}

Therefore, take as the first criterion: when Ē_{signal}>E_{speech}, then the current signal analysis window will be deemed a speech candidate; and when Ē_{signal}<Eₙₒᵢₛₑ, then the current signal analysis window will be deemed a noise candidate. In order to track the changing environmental noise and speech conditions, update the speech threshold when the current signal analysis window is a speech candidate and similarly update the noise threshold when the current signal analysis window is a noise candidate:

$$\begin{matrix}{E}_{speech} ( t + 1 ) = {ρ}_{speech} ( \begin{matrix}α {E}_{speech} ( t ) + \\ ( 1 - α ) {\overline{E}}_{signal} ( t )\end{matrix} ) & if {\overline{E}}_{signal} ( t ) > {E}_{speechl} ( t ) \\ = {E}_{speech} ( t ) & otherwise\end{matrix}$$

$$\begin{matrix}{E}_{noise} ( t + 1 ) = {ρ}_{noise} ( \begin{matrix}β {E}_{noise} ( t ) + \\ ( 1 - β ) {\overline{E}}_{signal} ( t )\end{matrix} ) & if {\overline{E}}_{signal} ( t ) < {E}_{noise} ( t ) \\ = {E}_{noise} ( t ) & otherwise\end{matrix}$$

where 0<α, β<1, ρ_{speech}, and ρₙₒᵢₛₑ are constants which control the speech and noise threshold levels, respectively. Typical values would be: α=0.999, β=0.9, ρ_{speech}=1.425, and ρₙₒᵢₛₑ=1.175. FIG. 2D illustrates a noisy speech signal and the corresponding thresholds.

For most cases, criterion (1) is able to maintain high accuracy in separating speech and noise. In a typical scenario, the driver speaks during fixed periods, and background noise is present through most of the input. Next, we consider a more complex situation where a person sitting next to the driver talks (interfering speech) during operation. Compared with environmental noise, the average Teager energy of the interfering speaker is strong enough to also be labeled as speech (i.e., the energy-based criterion is not capable of locating the direction of speech). Therefore, criterion (2) focuses on the angle of arrival.

(2) Independent of how the driver positions his head while speaking, the direction of his speech will be significantly different to that of a person sitting in the front passenger's seat. Therefore, in order to separate the driver and the front-seat passenger, we need a criterion to decide the direction of speech, (i.e., source location). A number of source localization methods have been proposed in array processing. Among these methods, preferred embodiments apply the adaptive least-mean-square (LMS) filter method as the most suitable for a car environment. It is known that the peak of the weight coefficients in the LMS method corresponds to the best delay between the reference signal s(t) and the desired signal s_{d}(t). Signals at discrete time, t=nTₛ will be denoted as s(n) and s_{d}(n). The LMS method adapts an FIR filter to insert a delay which is equal and opposite to that existing between the two signals. In an ideal situation, the filter weight corresponding to the true delay would be unity and all other weights would be zero. The preferred embodiment case, (not an ideal situation), takes mic1 in FIG. 2A as the desired microphone, and mic5 as the reference microphone; then we insert a delay that corresponds to the peak of the filter weight. According to the geometric structure of the microphone array and the arriving incident sound wave, we are able to locate the source from this delay. Obviously, if we take the axis between the center of the desired microphone (mic1) and reference microphone (mic5) as the standard axis, the desired source should be located within some symmetric area |θ|≦θₜₕᵣₑₛₕ from both sides of this axis.

(3) This final criterion is employed as a special case for car bump noise. In the speech adaptive beamforming (SA-BF) and the noise adaptive beamforming (NA-BF) the LMS algorithm the constant of adaptation is easily misadjusted by various types of input signals. Therefore, we need to address a number of special noise signals, such as road impulse/bump noise versus car passing on the highway noise. Bump noise has a high energy content, a rich spectrum and is typically impulsive in nature. Since this particular noise does not arrive from a particular direction, the above criteria (1)-(2) cannot recognize it accurately. Such an impulse noise signal can cause the LMS to misadjust, and therefore make the adaptive filters which use LMS to update their coefficients to become unstable and to severely distort the desired speech. Although we can set a very small step size to avoid filter instability, such a step size for impulsive bump noise will result in filter updates that are too slow to converge for typical speech signals. If filters in the SA-BF do not converge, then speech leakage will occur which results in serious speech distortion from the noise canceller in the NA-BF. Fortunately, impulse bump noise has obvious high-energy characteristics versus time, and thus the average Teager energy response will be higher than normal noisy speech and other noise types. Therefore, we can set a bump noise threshold during our implementation to avoid instability in the filtering process. If the average Teager energy is above this value, we label the current signal as bump noise. Since bump noise can occur with or without speech, we cannot mute the current signal to remove it. In a preferred embodiment implementation, we disable coefficient updates of all adaptive filters and simply allow the bump noise to pass through the filters, with the hope that the processed signal sounds more natural.

Finally, the signal analysis window is labeled as speech if and only if all three criteria are satisfied. The output of the constraint section is a speech/noise flag and switch, as shown in FIG. 2A, which we use to control subsequent processing.

### B. Speech Adaptive Beamformer (SA-BF)

FIG. 2A shows the detailed structure of the constrained switched adaptive beamformer (CSA-BF), where we assume the total number of microphones is five. FIG. 2B shows the speech adaptive beamforming (SA-BF) functional block of FIG. 2A; the SA-BF is to form an appropriate beam pattern for the desired speech and thereby enhance the speech signal. Since adaptive filters are used to perform the beam steering, the beam steering changes with a movement of the source. The degree of accuracy and speed of adaptation steering is decided by the convergence behavior of the adaptive filters. In a preferred embodiment implementation, we selected microphone 1 as the primary microphone, and built an adaptive filter between it and each of the other four microphones. These filters compensate for the different transfer functions between the speaker and the microphones of the array. The coefficients of these filters likely represent a replacement of the pure delay in delay and sum beamforming (DASB), and are updated using a normalized least mean square method only when the current signal is detected as speech. There are two kinds of output from the SA-BF: namely, the enhanced speech d(n) and the four noise signals e₁₂(n), e₁₃(n), e₁₄(n), e₁₅(n) which are computed along with the filter updates:

d(n)=(1/5)Σ_{1≦k≦5} [symbol] w₁ₖ(n)|xₖ(n)

[symbol]

e₁ⱼ(n)= [symbol] w₁₁(n)|x₁(n) [symbol] − [symbol] w₁ⱼ(n)|xⱼ(n)

[symbol]

w₁ⱼ(n+1)=w₁ⱼ(n)+μ e₁ⱼ(t)xⱼ(n)/ [symbol] xⱼ(n)|xⱼ(n)

[symbol]

for microphone channels j=2,3,4,5 and where xₖ(n) denotes the vector of samples centered at xₖ(n) and which are involved in the filtering where the filters w₁ₖ are taken to have 2L+1 taps:

$${x}_{k} ( n ) = [ \begin{matrix}{x}_{k} ( n - L ) \\ … \\ {x}_{k} ( n - 1 ) \\ {x}_{k} ( n ) \\ {x}_{k} ( n + 1 ) \\ … \\ {x}_{k} ( n + L )\end{matrix} ]$$

and [symbol] .|. [symbol] denotes scalar product of vectors of length 2L+1.

The d(n) and e₁ⱼ(n) equations form an adaptive blocking matrix for the noise reference and a near-field solution for the desired signal, where w₁₁ is a fixed filter. This filter should be chosen carefully if there are special requirements necessary for filtering of the target signal. In a preferred embodiment implementation, we will assign this filter to be a delay in the data sequence. Here, the weight coefficients are updated using the Normalized Least-Mean-Square method only during instances where the current input signal includes the desired speech. Also, a step-size parameter controls the rate of convergence of the method.

### C. Noise Adaptive Beamformer (NA-BF)

NA-BF processing operates in a scheme like a multiple noise canceller, in which both the reference speech signal of the noise canceller and the speech free noise references are provided by the output of the speech adaptive beamformer (SA-BF). FIG. 2C shows the NA-BF where the input d(n) is the output of the SA-BF of FIG. 2B, and the inputs s₂(n), . . . , s₅(n) are the error outputs e₁₂(n), . . . , e₁₅(n) from the SA-BF. Since the filter coefficients are updated only when the current signal is detected as a noise candidate, they form a beam that is directed toward the noise. This is the reason it is referred to as a noise adaptive beamformer (NA-BF). The output response for high SNR improvement is given as follows:

sⱼ(n)=e_{1,j}(n)

y(n)= [symbol] w₂₁(n)|d(n) [symbol] −Σ_{2≦j≦5} [symbol] w₂ⱼ(n)|sⱼ(n)

[symbol]

w₂ⱼ(n+1)=w₂ⱼ(n)+μ y(t)sⱼ(n)/ [symbol] sⱼ(n)|sⱼ(n)

[symbol]

for microphone channels j=2, 3, 4, 5.

### 3. Adaptive Step Sizes

Since adaptive filters are used to perform the beam steering in CSA-BF, the beam pattern changes with a movement of the source. The speed of beam steering adaptation is determined by the convergence behavior of the adaptive filters. The step size μ plays a significant role in controlling the performance of the LMS method. A larger step-size parameter may be required to minimize the transient time of the LMS method, but on the other hand, to achieve small misadjustments a small step-size parameter has to be used. In order to balance the conflicting requirements, the preferred embodiments include an adaptive step size method.

The preferred embodiment adaptive step size methods choose the SA-BF step size based on the L² norm of the current filter coefficients (tap weights) and the squared error. The smaller L² norm of the filter coefficients indicates the adaptation has just started, and therefore we select a larger step size in order to minimize the transient time. A large error output may result in large misadjustment, so we decrease the step size for this case.

That is, the preferred embodiment SA-BF update method has three inputs (i) the filter tap-weight vector w(n), (ii) the current signal vector x(n), and (iii) the desired output d(n). The three outputs are: the filter output y(n), the error e(n), and the updated tap-weight vector w(n+1). And the computations are:

### (1) Apply Filtering:

y(n)= [symbol] w(n)|x(n)

[symbol]

### (2) Estimate Error

e(n)=d(n)−y(n)

### (3) Select Step Size

μ(n+1)=ƒ(∥w∥/(α∥x(n)∥²+βe(n)²))

### (4) Update Tap-Weights:

w(n+1)=w(n)+μ(n+1)e(t)x(n)

The function ƒ(.) is monotonic and may be between an exponential and a step function as illustrated in FIG. 1B. Typical parameter values are α=0.9 and β=0.1

The noise adaptive stage of the CSA-BF operates in a scheme like a multiple generalized side-lobe canceller (GSC). It is well known that the traditional GSC performs poorly at high signal-to-interference ratio (SIR), and degrades the desired signal. This is because under realistic conditions some desired signals leak into the reference signals, such as signals s₁(n), s₂(n), s₃(n), s₄(n), s₅(n), shown in FIG. 2A, due to mis-steering, inaccurate delay compensation, or sensor mismatch; and the misadjustment of the adaptive weights is proportional to the desired signal strength even in the ideal case. In order to resolve this problem, the preferred embodiments use an adaptive step size method for filter adaptation of the noise adaptive second stage. We first estimate the SIR at the second stage inputs by

SIR(n)=Ē_{d}/Σ_{1≦i≦M} Ēₛᵢ

where, as before, M (=5 in FIG. 2A) is the number of microphones and the energy averages are over windows of size N (=256 above) samples:

Ē_{d}=(1/N)Σ_{1≦n≦N} {d(n)²−d(n+1)d(n−1)}

Ēₛᵢ=(1/N)Σ_{1≦n≦N} {sᵢ(n)²−sᵢ(n+1)sᵢ(n−1)}

Then select the corresponding step size μ according to the FIG. 1C relationship plot between the estimated SIR and step size.

### 4. Post Processor for CSA-BF

FIG. 1A illustrates a speech enhancement post-processor applied to the output of the CSA-BF to further reduce residual noise. The preferred embodiment system has a minimum mean-squared error (MMSE) speech enhancement post-processor analogous to that described in cross-reference application [TI-64450]. In particular, preferred embodiment methods apply a frequency-dependent gain to an audio input to estimate the speech where an estimated SNR determines the gain from a codebook based on training with an MMSE metric. In more detail, preferred embodiment methods of generating enhanced speech estimates proceed as follows. Presume a digital sampled speech signal, s(n), which has additive unwanted noise, w(n), so that the observed signal, y(n), can be written as:

y(n)=s(n)+w(n)

The signals are partitioned into frames (either windowed with overlap or non-windowed without overlap). An N-point FFT transforms the frame to the frequency domain. Typical values could be 20 ms frames (160 samples at a sampling rate of 8 kHz) and a 256-point FFT.

N-point FFT input consists of M samples from the current frame and L samples from the previous frame where M+L=N. L samples will be used for overlap-and-add with the inverse FFT. Transforming gives:

Y(k, r)=S(k, r)+W(k, r)

where Y(k, r), S(k, r), and W(k, r) are the (complex) spectra of s(n), w(n), and y(n), respectively, for sample index n in frame r, and k denotes the discrete frequency bin in the range k=0, 1, 2, . . . , N−1 (these spectra are conjugate symmetric about the frequency bin N/2). Then the preferred embodiment estimates the speech by a scaling in the frequency domain:

Ŝ(k, r)=G(k, r)Y(k, r)

where Ŝ(k, r) estimates the noise-suppressed speech spectrum and G(k, r) is the noise suppression filter gain in the frequency domain. The preferred embodiment G(k, r) depends upon a quantization of ρ(k, r) where ρ(k, r) is the estimated signal-to-noise ratio (SNR) of the input signal for the kth frequency bin in the rth frame and Q indicates the quantization:

G(k, r)=lookup {Q(ρ(k, r))}

In this equation lookup { } indicates the entry in the gain lookup table (constructed by training data), and:

ρ(k, r)=|Y(k, r)|²/|Ŵ(k, r)|²

where Ŵ(k, r) is a long-run noise spectrum estimate which can be generated in various ways.

A preferred embodiment long-run noise spectrum estimation updates the noise energy level for each frequency bin, |Ŵ(k, r)|², separately:

$$\begin{matrix}{\vert \hat{W} ( k , r ) \vert}^{2} = κ {\vert \hat{W} ( k , r - 1 ) \vert}^{2} & if {\vert Y ( k , r ) \vert}^{2} > κ {\vert \hat{W} ( k , r - 1 ) \vert}^{2} \\ = λ {\vert \hat{W} ( k , r - 1 ) \vert}^{2} & if {\vert Y ( k , r ) \vert}^{2} < λ {\vert \hat{W} ( k , r - 1 ) \vert}^{2} \\ = {\vert Y ( k , r ) \vert}^{2} & otherwise\end{matrix}$$

where updating the noise level once every 20 ms uses κ=1.0139 (3 dB/sec) and λ=0.9462 (−12 dB/sec) as the upward and downward time constants, respectively, and |Y(k, r)|² is the signal energy for the kth frequency bin in the rth frame.

Then the updates are minimized within critical bands:

|Ŵ(k, r)|²=min{|Ŵ(k_{lb}, r)|², . . . , |Ŵ(k, r)|², . . . , |Ŵ(k_{ub}, r)|²}

where k lies in the critical band k_{lb}≦k≦k_{ub}. Recall that critical bands (Bark bands) are related to the masking properties of the human auditory system, and are about 100 Hz wide for low frequencies and increase logarithmically above about 1 kHz. For example, with a sampling frequency of 8 kHz and a 256-point FFT, the critical bands (in multiples of 8000/256=31.25 Hz) would be:

| critical band | frequency range |
|---|---|
| 1 | 0-94 |
| 2 | 94-187 |
| 3 | 188-312 |
| 4 | 313-406 |
| 5 | 406-500 |
| 6 | 500-625 |
| 7 | 625-781 |
| 8 | 781-906 |
| 9 | 906-1094 |
| 10 | 1094-1281 |
| 11 | 1281-1469 |
| 12 | 1469-1719 |
| 13 | 1719-2000 |
| 14 | 2000-2312 |
| 15 | 2313-2687 |
| 16 | 2687-3125 |
| 17 | 3125-3687 |
| 18 | 3687-4000 |

Thus the minimization is on groups of 3-4 ks for low frequencies and at least 10 for critical bands 14-18. Lastly, Ŝ(k, r)=Y(k, r) G(k, r) is inverse transformed to recover the enhanced speech.

### 5. Microphone Array

Preferred embodiment multi-microphone based speech acquisition systems suitable for cell phones can employ the preferred embodiment CSA-BF plus MMSE post-processing methods. To achieve high noise reduction performance with a beamforming method, the two outermost microphones should be placed as far apart as possible. However, for different phone models, such as flip phone and compact one-piece phone, the furthest distance can be very different. Another problem is that the multi-microphone arrangement that is good for left-hand users might perform badly for right-hand users, as the sound propagation path to some microphones can be partially or fully blocked. Also, because the user can use the cell phone in both handheld and hands-free modes, the distances between the source (speaker's mouth) and microphones are different for each mode, which will affect the speech signal acquired by the microphones.

FIG. 1D is an engineering drawing which shows a preferred embodiment microphone array for cell phones with a rectangular front-side (front panel); of course, the cellphone corners would be rounded and the parallel sides would be curved (bowing out) so that the front panel is only substantially rectangular as opposed to exactly rectangular. The multi-microphone arrays are suitable for various cell phone models, such as flip phones, slide phones, and compact one-piece phones. For each of the phone model, this system may include sub-systems with 2, 3, 5, or 7 microphones, which are suitable for both right-hand and left-hand users at both hands-free and handheld modes. Each subsystem forms one speech beam and one or more noise beams depending on the number of microphones.

Three microphone based subsystem consists of two linear sub-arrays, and each sub-array includes two microphones. Five microphone based subsystem consists of two non-linear sub-arrays, and each sub-array includes three microphones with either equal or logarithmic spacing. Seven microphone based subsystem consists of two non-linear sub-arrays, and each sub-array includes four microphones.

The eight microphones, each designated by a circled number in FIG. 1D, form the following sub-arrays:
Microphone #1:

Primary microphone, located in the middle of the bottom on the front panel of the cell phone, which is suitable for both left-hand and right-hand users. Note that FIG. 1D shows the front panel on the left and the back panel on the right.
Microphone #1 and #8:

2-microphone based noise canceller.
Microphone #1, #4, and #5:

3-microphone system for cell phones.
Microphone #1, #3, #4, #5, and #6:

5-microphone system for cell phones. Mic. #1, #3, #4 and Mic. #1, #6, #5 consists of two logarithmic spaced linear arrays.
Microphone #1, #2, #4, #5, and #7:

5-microphone system for cell phones. Mic. #1, #2, #4 and Mic. #1, #7, #5 comprise two equal spaced linear arrays. This configuration is suggested when Mic #3 and #6 are not applicable because of the phone display.
Microphone #1, #2, #3, #4, #5, #6, and #7:

7-microphone system for cell phones. Mic. #1, #2, #3, #4 and Mic. #1, #7, #6, #5 comprise two non-uniform linear arrays.
Microphone #1, #3, and #6:

3-microphone system for cell phones.
Microphone #1, #2, #3, #6, and #7:

5-microphone system for cell phones. Mic. #1, #2, #3 and Mic. #1, #7, #6 comprise two logarithmic spaced linear arrays.

The following table lists SNR of the audio file in dB for real data collected using a multi-microphone device:

| | Methods | | | |
|---|---|---|---|---|
| Noise Cond | Unprocessed | CSA | MMSE | CSA-MMSE |
| Hands-free Highway | 4.4885 | 8.9126 | 9.9916 | 18.2172 |
| Handheld Highway | 7.4066 | 13.0544 | 15.1028 | 24.7788 |
| Hands-free Cafeteria | 9.9026 | 12.1147 | 17.6447 | 19.7609 |

### 7. Modifications

The preferred embodiments can be modified in various ways. For example, the various parameters and thresholds could have different values or be adaptive, other single-channel noise reduction could replace the MMSE speech enhancement, the adaptive step-size methods could be different, and so forth.

While the foregoing is directed to embodiments of the present invention, other and further embodiments of the invention may be devised without departing from the basic scope thereof, and the scope thereof is determined by the claims that follow.

What is claimed is:

1. An audio device, comprising:
(a) a microphone array;
(b) a constrained switched adaptive beamformer with input coupled to said microphone array, said beamformer including (i) a first stage speech adaptive beamformer with first adaptive filters having a first adaptive step size, and (ii) a second stage noise adaptive beamformer with second adaptive filters having a new second adaptive step size; and
(c) a single channel speech enhancer with input coupled to an output of said constrained switched adaptive beamformer.

2. The audio device of claim 1, wherein said first adaptive step size is determined by a function of a measure of filter coefficient magnitudes.

3. The device of claim 1, wherein said second adaptive step size is determined by signal-to-interference ratio.

4. An audio device, comprising:
(a) a primary microphone located on a panel of said audio device about a first short edge of said panel;
(b) a first microphone array on said panel and including said primary microphone, said first microphone array extending about a first long edge of said panel;
(c) a second microphone array on said panel and including said primary microphone, said second microphone array extending about a second long edge of said panel, said second long edge opposite said first long edge; and
(d) beamformer circuitry in said audio device coupled to microphones of said first and second microphone arrays.
